(19) United States
(12) Patent Application Publication
(10) Pub. No.: US 2022/0075032 A1
(43) Pub. Date: Mar. 10, 2022

(54) LASER TRANSCEIVING MODULE AND LIDAR

(71) Applicant: SUTENG INNOVATION TECHNOLOGY CO., LTD., Shenzhen (CN)

(72) Inventor: Ji WANG, Shenzhen (CN)

(73) Assignee: SUTENG INNOVATION TECHNOLOGY CO., LTD., Shenzhen (CN)

(21) Appl. No.: 17/527,072

(22) Filed: Nov. 15, 2021

Related U.S. Application Data
(63) Continuation of application No. PCT/CN2020/070281, filed on Jan. 3, 2020.

(51) Int. Cl. G01S 7/481; G01S 7/499; G01S 17/46

(52) U.S. Cl. CPC G01S 7/4813; G01S 17/46; G01S 7/499

(57) ABSTRACT

Embodiments of a laser transceiving module and a LiDAR are disclosed. The laser transceiving module includes a housing; an emitting module configured to emit emergent laser signals; a laser splitting module; and a receiving module. The emergent laser signals emit, through the laser splitting module, outwards and are reflected by a target object in a detection region to return reflected laser signals. The laser splitting module is configured to deflect the reflected laser signals. The receiving module is configured to receive the deflected reflected laser signals. The emitting module, the laser splitting module, and the receiving module are fixed at the housing. An extinction structure is arranged between the emitting module and the laser splitting module and is configured to prevent the emergent laser signals that are reflected by the laser splitting module from emitting to the receiving module.

### CROSS-REFERENCE TO RELATED APPLICATIONS

The present application is a bypass continuation of PCT/CN2020/070281 with an international filing date of Jan. 3, 2020, the entirety of which is hereby incorporated herein by reference.

### TECHNICAL FIELD

The present disclosure relates to the technical field of LiDAR, and more particularly, to a laser transceiving module and LiDAR.

### BACKGROUND

LiDAR is an active detection sensor. The working principle of the LiDAR is to measure relevant information of a target object by emitting a laser beam from an emitting module and detecting echo signals of the target object by a receiving module, such as measuring a distance, an orientation, a height, a speed, a posture, even a shape and other information.

In the existing LiDAR technology, an issue, due to the influence of stray light, that the LiDAR has a poor detection ability or is even unable to detect is inevitable. The stray light that exists in the LiDAR usually contains external stray light and internal stray light. The external stray light is generally formed by laser of another LiDAR or sunlight entering the LiDAR. The internal stray light is mainly formed by emergent laser signals or reflected laser signals being scattered by the inner wall of a structure or being reflected or scattered by the surface of an optical element. Either the internal stray light or the external stray light will affect the accuracy and ranging ability of the LiDAR.

### SUMMARY

Based on the shortcomings of the conventional skills, an objective of the present disclosure is to provide a laser transceiving module and a LiDAR that are capable of reducing stray light, thereby improving the accuracy and ranging ability of the LiDAR.

According to a first aspect of the present disclosure, the present disclosure proposes a laser transceiving module that includes: a housing; an emitting module configured to emit emergent laser signals; a laser splitting module; and a receiving module. The emergent laser signals emit, through the laser splitting module, outwards and are reflected by a target object in a detection region to return reflected laser signals. The laser splitting module is configured to deflect the reflected laser signals. The receiving module is configured to receive the deflected reflected laser signals. The emitting module, the laser splitting module, and the receiving module are fixed at the housing. An extinction structure is arranged between the emitting module and the laser splitting module and is configured to prevent the emergent laser signals that are reflected by the laser splitting module from emitting to the receiving module.

In some embodiments of the present disclosure, the extinction structure is arranged at the housing. The extinction structure includes a first reflecting surface and a second reflecting surface that forms an angle with the first reflecting surface. One end of the first reflecting surface is close to the emitting module, and another end of the first reflecting surface is connected with the second reflecting surface. One end of the second reflecting surface is connected with the first reflecting surface, and another end of the second reflecting surface is close to the laser splitting module.

In some embodiments, each of the first reflecting surface and the second reflecting surface includes a plane. The angle formed by the first reflecting surface and the second reflecting surface is an obtuse angle.

In some embodiments, the second reflecting surface is approximately perpendicular to the laser splitting module.

In some embodiments, a light-absorbing layer is formed on at least one of the first reflecting surface or the second reflecting surface.

In some embodiments, the emitting module includes a laser device and a collimating module. The laser device is configured to generate the emergent laser signals. The collimating module is configured to collimate the emergent laser signals. The collimating module includes a fast-axis collimating lens group and a slow-axis collimating lens group. A first emitting diaphragm is arranged at a front side of an emergent end of the collimating module. A second emitting diaphragm is arranged between the fast-axis collimating lens group and the slow-axis collimating lens group.

In some embodiments, the first emitting diaphragm includes a circular first light-passing hole.

In some embodiments, the second emitting diaphragm includes at least one second emitting sub-diaphragm, and each of the at least one second emitting sub-diaphragm includes a plurality of light blocking blocks arranged up and down correspondingly.

In some embodiments, the receiving module includes a focusing module and a detector. The focusing module is configured to converge the reflected laser signals. The detector is configured to receive the converged reflected laser signals. The focusing module includes a receiving converging lens group and a receiving correcting lens group. A first receiving diaphragm is arranged between the receiving converging lens group and the receiving correcting lens group. A second receiving diaphragm is arranged at a front side of an emergent end of the focusing module.

In some embodiments, the first receiving diaphragm is movable and adjustable along axial and radial directions of an optical axis of the receiving module.

In some embodiments, a detachable adjusting base is provided at the first receiving diaphragm. The first receiving diaphragm is moved and adjusted by clamping the adjusting base. After the first receiving diaphragm is adjusted and fixed, the adjusting base is removed.

In some embodiments, the first receiving diaphragm includes a circular second light-passing hole. The second receiving diaphragm includes a third light-passing hole.

According to another aspect of the present disclosure, the present disclosure further provides a LiDAR that includes at least one of the disclosed laser transceiving module.

In some embodiments, the LiDAR further includes a galvanometer assembly configured to receive emergent laser signals emitting from the laser transceiving module, emit the emergent laser signals outwards to scan, and receive reflected laser signals returned coaxially and emit the reflected laser signals to the at least one laser transceiving module. The LiDAR further includes a housing assembly having a base and an upper housing. A window sheet is formed on a side wall of the upper housing. The galvanometer assembly and the at least one laser transceiving module are arranged in the housing assembly. The emergent laser signals emit outwards through the window sheet, and the reflected laser signals emit, through the window sheet, to the housing assembly.

In some embodiments, the window sheet is arranged obliquely.

In some embodiments, the LiDAR includes a mirror lens assembly. The mirror lens assembly includes mirror lenses. A number of the mirror lenses corresponds to a number of the at least one laser transceiving module. The emergent laser signals emitting from each of the at least one laser transceiving module are reflected by a corresponding mirror lens and emit to the galvanometer assembly. The reflected laser signals received by the mirror lens assembly emit to the mirror lens, and emit to the corresponding laser transceiving module after being reflected by the mirror lens.

In some embodiments, the LiDAR includes a bracket between the laser transceiving module and the mirror lens assembly, and a light-passing port formed at the bracket. The emergent laser signals that emit from the corresponding laser transceiving module pass through the light-passing port, and the reflected laser signals are received, through the light-passing port, by the corresponding laser transceiving module.

In some embodiments, a light-absorbing layer is formed on at least one of a side of the bracket facing the mirror lens assembly or a side of the bracket facing the laser transceiving module.

In some embodiments, at least one of the following applies: one galvanometer diaphragm is arranged at a front side of the working surface of the galvanometer assembly, or the light-absorbing layer is provided at a base on the working surface of the galvanometer assembly.

In some embodiments, the light-absorbing layer is provided at an inner surface of the upper housing below the window sheet.

Compared with the conventional skills, the present disclosure has the following advantages:

For the laser transceiving module:

1) The extinction structure may effectively prevent part of the laser signals in the emergent laser signals emitting from the emitting module from being reflected by the laser splitting module, and from being scattered by the inner wall of the housing multiple times, and from becoming stray light directly received by the receiving module, thereby effectively reducing the stray light inside the laser transceiving module.

2) Owing to the arrangement of the first emitting diaphragm and the second emitting diaphragm, for example, the plurality of diaphragms are arranged in the emitting module, the stray light generated by the excess emergent laser signals reflected and scattered by the inner wall of the housing may be restricted as much as possible. Therefore, the stray light inside the laser transceiving module may be further reduced.

3) Owing to the arrangement of the first receiving diaphragm (adjustable in a position) and the second receiving diaphragm, it is possible to limit other laser signals emitting to the detector and reduce the stray light entering the detector without blocking the reflected laser signals.

For the LiDAR:

1) Owing to the inclined arrangement of the window sheet, the emergent laser signals within the full scanning range of the galvanometer assembly is not perpendicular to the window sheet after being reflected by the galvanometer assembly, thereby preventing part of the emergent laser signals from being received by the galvanometer assembly after being reflected by the window sheet, and then from entering the laser transceiving module, which reduces the stray light generated inside the LiDAR and improves the short-distance measurement capability of the LiDAR.

2) A light-passing port arranged on the bracket may function as the diaphragm, and may simultaneously suppress the stray light of an external sun background and suppress the crosstalk between optical path channels of the plurality of internal laser transceiving modules. The light-absorbing layer is arranged at the front and back sides of the bracket, thereby reducing part of light restricted by the bracket to be reflected or scattered by the bracket and then emit to the laser transceiving module, reducing the stray light generated inside the LiDAR and improving the short-distance measurement capability of the LiDAR.

3) Extinction is performed behind the mirror lens assembly, for example, under the window sheet, to prevent the condition when emergent laser signals emitting from the laser transceiving module emit to the mirror lens assembly, part of the emergent laser signals are not received by the mirror lens assembly, but reflected by the inner wall of the upper housing behind the mirror lens assembly and emits towards the laser transceiving module, which may reduce the stray light generated inside the LiDAR.

4) By adding the galvanometer diaphragm with a certain aperture in front of the galvanometer assembly or forming a light-absorbing layer on the base on the working surface, the stray light emitting to the galvanometer assembly may be restricted as much as possible without blocking the emergent laser signals and the reflected laser signals. The stray light generated after the emergent laser signals and the reflected laser signals emitting to the galvanometer assembly are reflected by the base is also reduced.

The laser transceiving module reduces the internal stray light therein. The LiDAR reduces the internal stray light, the external stray light, and the crosstalk among the plurality of laser transceiving modules. A large random noise caused by the external stray light is avoided. The noise of a point cloud is significantly reduced. The ranging ability of the LiDAR is improved. The detector is avoided from being saturated in advance after the internal stray light is received by the receiving module. The reflected laser signals that rapidly return at a close distance cannot be responded. Leading interference is formed to cause a short-distance blind region. The ranging ability and accuracy of the LiDAR are improved. The crosstalk of optical path channels of the plurality of laser transceiving modules inside the LiDAR is reduced. The accuracy of the LiDAR is improved.

### BRIEF DESCRIPTION OF THE DRAWINGS

FIG. 1 is a perspective view of a structure of a laser transceiving module according to an embodiment of the present disclosure.

FIG. 2 is a front view of an internal structure of the laser transceiving module shown in FIG. 1.

FIG. 3 is a perspective view of an internal structure of the laser transceiving module shown in FIG. 1.

FIG. 4 is a schematic view of a structure of a first receiving diaphragm shown in FIG. 3.

FIG. 5 is a functional diagram of a first embodiment of a laser transceiving module according to an embodiment of the present disclosure.

FIG. 6 is a functional diagram of a second embodiment of a laser transceiving module according to an embodiment of the present disclosure.

FIG. 7 is a perspective view of a structure of a LiDAR according to an embodiment of the present disclosure.

FIG. 8 is a schematic view of an inner structure of the LiDAR shown in FIG. 7.

FIG. 9 is a side view of the LiDAR shown in FIG. 8.

FIG. 10 is a schematic view of a structure of a bracket shown in FIG. 8.

FIG. 11 is a schematic view of a structure of a galvanometer assembly shown in FIG. 8.

### DETAILED DESCRIPTION

In order to better understand the objectives, structures and functions of the present disclosure, the following describes the present disclosure in detail with reference to the drawings.

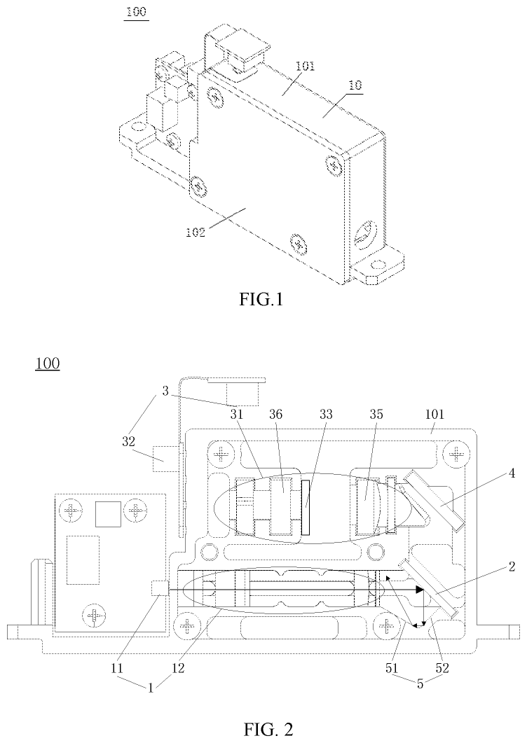

FIGS. 1-3 show a structure of a laser transceiving module 100 according to an embodiment of the present disclosure. With a reference to FIG. 5, the laser transceiving module 100 may include a housing 10, and an emitting module 1, a laser splitting module 2, and a receiving module 3 that may be fixed at the housing 10. Emergent laser signals from the emitting module 1 emit outwards after passing through the laser splitting module 2, and may be reflected by a target object 300 in a detection region to return reflected laser signals. The reflected laser signals may be received by the laser splitting module 2, deflected, and then received by the receiving module 3. An extinction structure 5 may be arranged between the emitting module 1 and the laser splitting module 2. The extinction structure 5 may be configured to prevent the emergent laser signals reflected by the laser splitting module 2 from emitting toward the receiving module 3.

In the laser transceiving module 100 of the embodiment of the present disclosure, the laser splitting module 2 may serve as a hub connecting the emitting module 1 and the receiving module 3 to realize the coaxial transceiving of the laser transceiving module 100. If stray light is generated at the laser splitting module 2, the stray light easily emits to the receiving module 3 via an optical channel connecting the laser splitting module 2 and the receiving module 3. Through the arrangement of the extinction structure 5 between the emitting module 1 and the laser splitting module 2, it may be possible to effectively prevent part of the laser emitting from the emitting module 1 from being reflected by the laser splitting module 2, from being scattered by the inner wall of the housing 10 by multiple times and from becoming stray light directly received by the receiving module 2. Therefore, the stray light inside the laser transceiving module 100 may be effectively reduced. A short-distance blind region caused by leading interference may be avoided, thereby reducing the impact of the stray light on the ranging capability and accuracy of the laser transceiving module 100.

According to some embodiments of the present disclosure, the extinction structure 5 may have a plurality of structural forms. For example, the structural forms may include a reflecting surface of any shape. The extinction structure 5 may prevent the emergent laser signals reflected by the laser splitting module 2 from emitting to the receiving module 3. The extinction structure 5 may further include a light-absorbing layer provided on the reflecting surface, thereby avoiding the extinction structure 5 from reflecting or scattering the emergent laser signals to generate the stray light.

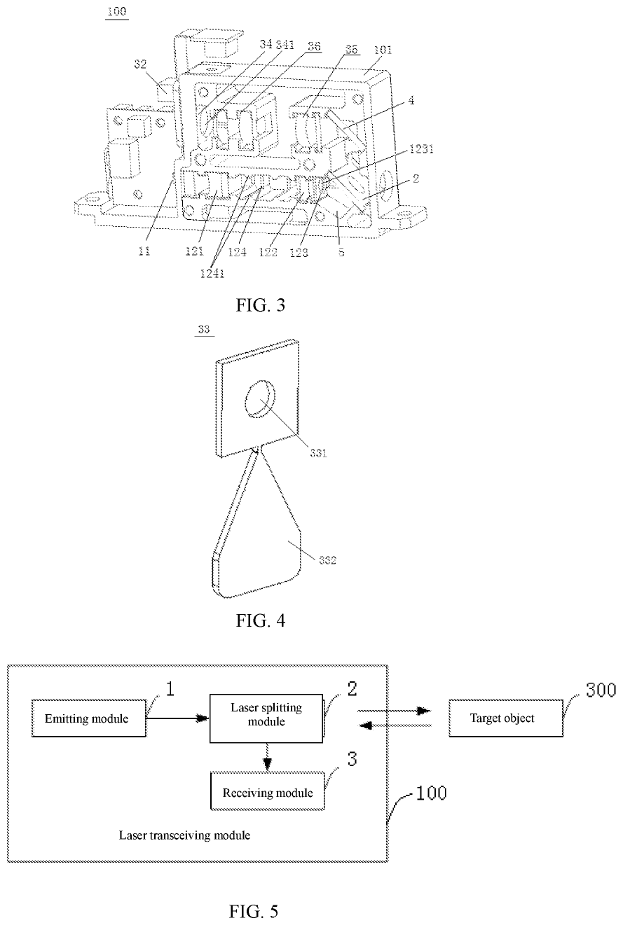

In some embodiments, the extinction structure 5 may include at least one reflecting surface. As shown in FIGS. 2 and 3, the extinction structure 5 may be arranged at the housing 10. The extinction structure 5 may include a first reflecting surface 51 and a second reflecting surface 52 that may be arranged at an angle. One end of the first reflecting surface 51 may be close to the emitting module 1, and another end thereof may be connected to the second reflecting surface 52. One end of the second reflecting surface 52 may be connected to the first reflecting surface 51, and another end thereof may be close to the laser splitting module 2. For example, the first reflecting surface 51 and the second reflecting surface 52 may form an V-shape as shown in FIG. 4. Part of the emergent laser signals reflected by the laser splitting module 2 may emit toward the extinction structure 5, for example, may emit toward the first reflecting surface 51 and/or the second reflecting surface 52. The part of the emergent laser signals reflected by the first reflecting surface 51 and the second reflecting surface 52 may obliquely emit to the emitting module 1 or the laser splitting module 2, and may not enter the receiving channel to emit to the receiving module 3, thereby reducing the internal stray light received by the receiving module 3.

It should be noted that the first reflecting surface 51 and the second reflecting surface 52 may be flat, curved, or irregular surfaces. It can be ensured that the stray light emitting to the receiving module 3 may be effectively eliminated after the emergent laser signals reflected by the laser splitting module 2 and emitting to the first reflecting surface 51 and the second reflecting surface 52 are reflected or absorbed by the first reflecting surface 51 and the second reflecting surface 52. Accordingly, the magnitude of the stray light emitting to the receiving module 3 may be reduced.

In some embodiments as shown in FIGS. 2 and 3, the first reflecting surface 51 and the second reflecting surface 52 may be both planes. An included angle between the first reflecting surface 51 and the second reflecting surface 52 may include an obtuse angle. As shown in FIG. 3, the laser splitting module 2 may include a polarizing laser splitting flat sheet obliquely arranged at an angle of 45°. P-polarized light in the emergent laser signals may pass through the polarizing laser splitting flat sheet and emit outwards. S-polarized light in the reflected laser signals may be reflected by the polarization laser splitting flat sheet and then may emit toward the receiving module 3, so as to realize the laser splitting of the emergent laser signals and the reflected laser signals. The laser splitting module 2 may also include a polarizing laser splitter, a mirror with a central circular hole, or a combined laser splitter (for example, a polarizing laser splitting sheet being provided at a circular hole of a mirror). The emergent laser signals may propagate in a horizontal direction and emit toward the laser splitting module 2 at an incident angle of 45°. Part of the emergent laser signals reflected by the laser splitting module 2 may propagate down along a vertical direction and emit toward the second reflecting surface 52. Considering that an included angle between the first reflecting surface 51 and the second reflecting surface 52 may be an obtuse angle, the part of the emergent laser signals emitting to the second reflecting surface 52 may be either reflected directly to the emitting module 1 or reflected to the first reflecting surface 51, and further reflected toward the emitting module 1. Through this arrangement, it may be avoided that part of the emergent laser signals reflected by the extinction structure 5 emit to the laser splitting module 2, and then emit to the receiving module 3 via the channel connecting the laser splitting module 2 and the receiving module 3, thereby greatly reducing the internal stray light emitting to the receiving module 3.

In some embodiments of the present disclosure, the included angle between the first reflecting surface 51 and the second reflecting surface 52 may range from 110° to 130°. In one embodiment, the included angle between the first reflecting surface 51 and the second reflecting surface 52 may range from 115° to 120°.

In some embodiments of the present disclosure, the second reflecting surface 52 may be approximately perpendicular to the laser splitting module 2. As mentioned above, the emergent laser signals may emit to the laser splitting module 2 at an incident angle of 45°. Part of the emergent laser signals reflected by the laser splitting module 2 may propagate down along a vertical direction and emit to the second reflecting surface 52. Considering that the second reflecting surface 52 may be approximately perpendicular to the laser splitting module 2, part of the emergent laser signals may be reflected by the second reflecting surface 52, then propagate along the horizontal direction, and emit to the first reflecting surface 51. The included angle between the first reflecting surface 51 and the second reflecting surface 52 may be an obtuse angle. Part of the emergent laser signals propagating along the horizontal direction may enter the first reflecting surface 51 at a large incident angle, then reflected by the first reflecting surface 51 and emit to the emitting module 1, thereby avoiding the internal stray light from emitting to the laser splitting module 2 and the receiving module 3.

In some embodiments of the present disclosure, a projection of a working area on a horizontal plane where the laser splitting module 2 receives the emergent laser signals may not exceed a projection area of the second reflecting surface 52 on the horizontal plane. In this way, the part of the emergent laser signals reflected by the laser splitting module 2 may emit to the second reflecting surface 52, rather than emitting to the first reflecting surface 51. According to this reflecting path, all of the internal stray light may finally emit to the emitting module 1 and may have no effect on the receiving module 3.

In some embodiments of the present disclosure, to further reduce the internal stray light generated by laser reflecting or scattering on the first reflecting surface 51 and/or the second reflecting surface 52, a light-absorbing layer (not shown in the figure) may be formed on the first reflecting surface 51 and/or the second reflecting surface 52. The light-absorbing layer may include one of a light-absorbing paper, a light-absorbing film, and an extinction coating.

In some embodiments, the extinction structure 5 may also include a light-absorbing layer. The light-absorbing layer (not shown in the figure) may be provided at a region between the emitting module 1 and the laser splitting module 2. The light-absorbing layer may include one of a light-absorbing paper, a light-absorbing film, and an extinction coating. Part of the emergent laser signals reflected by the laser splitting module 2 may emit to the light-absorbing layer. Part of the emergent laser signals may be absorbed by the light-absorbing layer. Accordingly, no internal stray light reflected on the extinction structure 5 may emit upward to the receiving module 3.

In some embodiments, as shown in FIG. 2, the emitting module 1 may include a laser device 11 and a collimating module 12. The laser device 11 may be configured to generate the laser signals, and the collimating module 12 may be configured to collimate the laser signals. As shown in FIG. 3, the collimating module 12 may include a fast-axis collimating lens group 121 and a slow-axis collimating lens group 122. A first emitting diaphragm 123 may be arranged at a front side of an emitting end of the collimating module 12. A second emitting diaphragm 124 may be arranged between the fast-axis collimating lens group 121 and the slow-axis collimating lens group 122. Because the emergent laser signals have a certain diffusion angle when emitting, the laser beam does not emit completely in parallel. After the emergent laser signals propagate for a certain distance, part of laser light in a margin emitting to a side wall of the housing 10 of an emitting channel is reflected or reflected by a plurality of times, emits to the receiving module 3, and becomes the internal stray light. Therefore, the first emitting diaphragm 123 and the second emitting diaphragm 124 may be arranged to limit the internal stray light on a propagation path of the non-emergent laser signals, thereby achieving the objective of further reducing the stray light inside the laser transceiving module 100. It should be noted that the location of the second emitting diaphragm 124 may be arranged according to the specific conditions of the emergent laser, which is not limited herein.

Further, as shown in FIG. 3, the second emitting diaphragm 124 may include at least one second emitting sub-diaphragm 1241. Each of the second emitting sub-diaphragm 1241 may include light blocking blocks arranged up and down correspondingly. A fast-axis direction of the emergent laser signals passing through the fast-axis collimating lens group 121 may be collimated, but a slow-axis direction may still have a diffusion angle. Therefore, the light blocking blocks arranged up and down correspondingly in the second emitting sub-diaphragm 1241 may limit the internal stray light generated by the slow axis direction. In some embodiments, through the arrangement of the plurality of second emitting sub-diaphragms 1241, the internal stray light may be restricted more effectively inside the emitting module 1. Generally, including at least two second emitting sub-diaphragms 1241 may limit 95% of the internal stray light. In some embodiments, considering the effect of the diaphragm and processing complexity of the structure, two second emitting sub-diaphragms 1241 may be provided between the fast-axis collimating lens group 121 and the slow-axis collimating lens group 122.

In some embodiments, the first emitting diaphragm 123 may include a first light-passing hole 1231 which may be a circular hole. The emergent laser signals emit to the laser splitting module 2 via the first light-passing hole 1231 of the first emitting diaphragm 123. Similar to the second emitting diaphragm 124, the first emitting diaphragm 123 may also be configured to limit the internal stray light on the propagation path of the non-emergent laser signals, thereby further reducing the stray light inside the laser transceiving module 100. The emergent laser signals that pass through the collimating module 12 may be almost parallel emergent laser, which may enable a cross-section of the emergent laser signals to form a circular spot so as to pass through the first light-passing hole 1231.

In addition, in some embodiments, the laser device 11 may include one of a semiconductor laser device and a fiber laser device. The collimating module 12 may include any of a ball lens, a ball lens group, a cylindrical lens group, a cylindrical lens plus a ball lens group, and a non-spherical lens or a gradient index lens.

In some embodiments, as shown in FIG. 2, the receiving module 3 may include a focusing module 31 and a detector 32. The focusing module 31 may be configured to converge the reflected laser signals. The detector 32 may be configured to receive the converged reflected laser signals. The focusing module 31 may include a receiving converging lens group 35 and a receiving correcting lens group 36. As shown in FIG. 4, a first receiving diaphragm 33 may be arranged between the receiving converging lens group 35 and the receiving correcting lens group 36. As shown in FIG. 3, the focusing module 31 may include a second receiving diaphragm 34 at a front side of an emergent end thereof The first receiving diaphragm 33 and the second receiving diaphragm 34 may be arranged to limit the internal stray light on a propagation path of non-reflected laser signals, thereby achieving the objective of further reducing the internal stray light of the laser transceiving module 100. Meanwhile, the first receiving diaphragm 33 and the second receiving diaphragm 34 may not affect the detector 32 to normally receive the reflected laser signals.

Further, the first receiving diaphragm 33 may include a second light-passing hole 331 which may be a circular hole. The second receiving diaphragm 34 may include a third light-passing hole 341. The reflected laser signals may be converged by the receiving converging lens group 35 and then emit to the receiving correcting lens group 36. A diameter of the second light- passing hole 331 may match a diameter of the converged reflected laser signal, so that normally-received reflected laser signals may enter the receiving correcting lens group 36 after being converged. A size of the third light-passing hole 341 may match a size of an optical spot of the converged and corrected reflected laser signals, so that both the converged and corrected reflected laser signals may emit to the detector 32. In some embodiments, the third light-passing hole 341 may be circular, elliptical, rounded square, etc. A shape of the third light-passing hole 341 may match a shape of a photosensitive surface of the detector 32.

In some embodiments, the focusing module 31 may include one of a ball lens, a ball lens group, and a cylindrical lens group. The detector 32 may be an Avalanche Photo Diode (APD), a Silicon photomultiplier (SiPM), an APD array, a Multi-Pixel Photon Counter (MPPC), a Photomultiplier Tube (PMT), a Single-photon Avalanche Diode (SPAD), etc.

In one embodiment, the first receiving diaphragm 33 may be movable and adjustable along axial and radial directions of a central optical axis of the receiving module 3. The collimating module 12, the laser splitting module 2, and the focusing module 31 may be all fixed in respective mounting positions thereof. Due to processing errors and assembly errors, a central optical axis of the reflected laser signals passing through the receiving converging lens group 35 and a central optical axis of the receiving correcting lens group 36 may be very likely to be non-collinear. As a result, if the first receiving diaphragm 33 is directly mounted and fixed so that a center of the first receiving diaphragm 33 is positioned on a central optical axis of the receiving correcting lens group 36, part of the normally-received reflected laser signals are blocked by the first receiving diaphragm 33 and may not be received by the detector 32. It greatly affects a receiving efficiency as well as a ranging ability and detection accuracy of the LiDAR. Therefore, the first receiving diaphragm 33 may be adjustable along axial and radial directions of the central optical axis so that the reflected laser signals have the best receiving effect. Alternatively, a threshold value may be set. When the first receiving diaphragm 33 is adjusted so that the received reflected laser signals exceeds the threshold, the adjustment may be considered complete.

In some embodiments, as shown in FIG. 4, a detachable adjusting base 332 may be also provided at the first receiving diaphragm 33. The first receiving diaphragm 33 may be moved and adjusted by clamping the adjusting base 332. After the first receiving diaphragm 33 is adjusted and fixed, the adjusting base 332 may be removed. The first receiving diaphragm 33 may be moved and adjusted by clamping the adjusting base 332 to prevent deformation, damage or contamination caused by directly clamping a body of the first receiving diaphragm 33. After the adjustment is completed and the first receiving diaphragm 33 is fixed, the adjusting base 332 may be removed. As shown in FIG. 1, the housing 10 may include a bottom case 101 and a side cover 102. After the emitting module 1, the laser splitting module 2 and the receiving module 3 are mounted and fixed at the bottom case 101, the side cover 102 may be covered, so that the emitting module 1, the laser splitting module 2 and the receiving module 3 are positioned in a cavity formed by the bottom case 101 and the side cover 102. Therefore, after the adjusting base 332 is removed, the side cover 102 may be mounted to complete the assembly of the laser transceiving module 100.

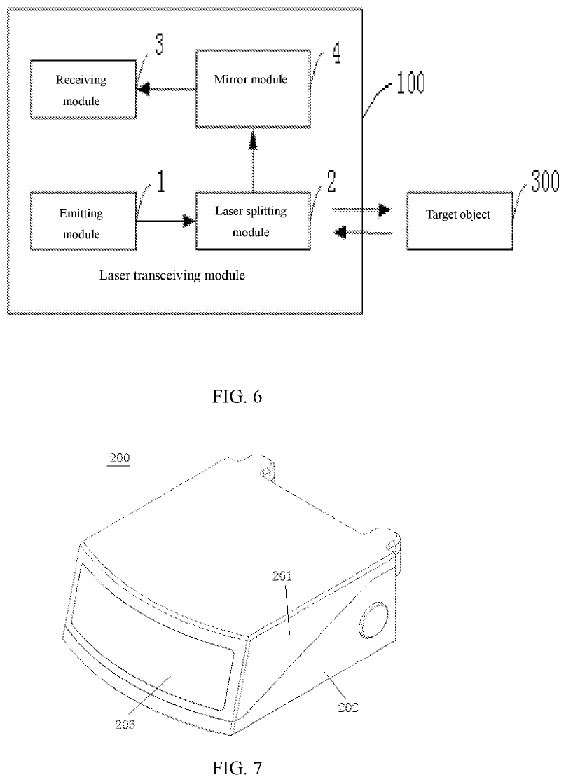

In some embodiments, as shown in FIGS. 2 and 3, the laser transceiving module 100 may further include a mirror module 4 between the laser splitting module 2 and the receiving module 3. As shown in FIG. 6, after the reflected laser signals pass through the laser splitting module 2, the reflected laser signals may be reflected by the mirror module 4 to the receiving module 3.

In some embodiments, as shown in FIG. 2, an optical axis of the reflected laser signals passing through the mirror module 4 may be parallel to an optical axis of the emergent laser signals. This arrangement may realize a folding and compression of the receiving optical path, and reduce the length of a space occupied by each module, so that the structure of the laser transceiving module 100 may be more compact. In other embodiments, the optical axis of the reflected laser signals passing through the mirror module 4 may also be at a certain angle from the optical axis of the emergent laser signals. The present disclosure does not limit thereto. The reflected laser signals passing through the mirror module 4 may be guaranteed to enter the receiving module 3.

FIGS. 7-9 show a schematic diagram of a structure of a LiDAR 200 according to an embodiment of the present disclosure. As shown in FIGS. 7-9, the LiDAR 200 may include at least one of the laser transceiving module 100 as described above.

In an embodiment shown in FIGS. 7-9, the LiDAR 200 may further include a galvanometer assembly 212 and a housing assembly. The galvanometer assembly 212 may be configured to receive emergent laser signals emitting from the laser transceiving module 100, and after reflecting the emergent laser signals, emit the emergent laser signals outwards to scan. The galvanometer assembly 212 may be also configured to receive reflected laser signals, e.g., the reflected laser signals returned coaxially, and emit the reflected laser signals to the laser transceiving module 100 after reflecting the laser signals. The housing assembly may include a base 202 and an upper housing 201. A window sheet 203 may be formed on a side wall of the upper housing 201. The galvanometer assembly 212 and the at least one laser transceiving module 100 may be arranged in the housing assembly. The emergent laser signals may emit out through the window sheet 203, and the reflected laser signals may emit to the inside of the housing assembly after passing through the window sheet 203.

In some embodiments, the window sheet 203 may be arranged obliquely, so that the emergent laser signals emitting after being reflected by the galvanometer assembly 212 is not be perpendicular to the window sheet 203. Considering that the window sheet 203 has a certain mirror reflection, if the emergent laser signals emitting after being reflected by the galvanometer assembly 212 is perpendicular to the window sheet 203, part of the emergent laser signals reflected by a mirror may also be approximately perpendicular to the window sheet 203 when returning and emitting to the galvanometer assembly 212. Part of the emergent laser signals may become stray light. The stray light may enter the laser transceiving module 100 via the galvanometer assembly 212 and may be received by the receiving module 3 in the laser transceiving module 100, resulting in a short-distance blind region. It may affect the ranging ability and accuracy of the LiDAR 200. Therefore, the window sheet 203 may be arranged obliquely so that the emergent laser signals are not perpendicular to the window sheet 203. Part of the emergent laser signals reflected by the window sheet 203 may emit in other directions and may not return to an original path to be received by the galvanometer assembly 212 and enter the laser transceiving module 100.

In some embodiments, as shown in FIG. 7, the window sheet 203 may be arranged obliquely downward. It is less possible that part of the emergent laser signals reflected by the window sheet 203 emit downward and are reflected or scattered by other structures in the housing assembly to enter the laser transceiving module 100.

It should be noted that a shape of the window sheet 203 may be flat or curved. It can be ensured that the emergent laser signals, within a scanning range of the galvanometer assembly 212, may not be perpendicular to the window sheet 203. The present disclosure does not place a specific limitation thereto. In some embodiments, a shape of the window sheet 203 may include a curved surface. Under the premise that the emergent laser signals and the reflected laser signals are not be blocked in an overall field view of the LiDAR 200, a width of the window sheet 203 may be reduced as much as possible, thereby providing a prerequisite for compressing an overall volume of the LiDAR 200.

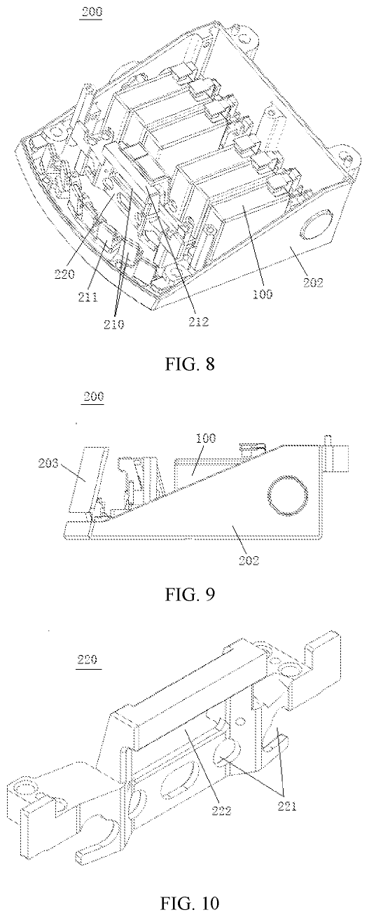

In an embodiment shown in FIG. 8 and FIG. 9, the LiDAR 200 may further include a mirror lens assembly 211. The mirror lens assembly 211 may include mirror lenses, and the number of the mirror lenses corresponds to the number of laser transceiving modules 100. The emergent laser signals emitting from each laser transceiving module 100 may be reflected by a corresponding mirror lens and then emit to the galvanometer assembly 212. The reflected laser signals received by the galvanometer assembly 212 may emit to the mirror lens and transmit to the corresponding laser transceiving module 100 after being reflected by the mirror lens. The mirror lens assembly 211 may be configured to fold an optical path, so as to achieve the objective of reducing the volume of the LiDAR 200.

In some embodiments, the emergent laser signals of the laser transceiving module 100 may emit to the corresponding mirror lens, and then emit to the galvanometer assembly 212. The galvanometer assembly 212 may emit the emergent laser signals to scan. The reflected laser signals reflected by a target object 300 may be received by the galvanometer assembly 212 and emit to the mirror lens. The mirror lens may reflect and emit the reflected laser signals to the corresponding laser transceiving module 100. The transceiving module 100 may receive the reflected laser signals.

Further, as shown in FIGS. 8 and 10, the LiDAR 200 may further include a bracket 220 between the laser transceiving module 100 and the mirror lens assembly 211. The bracket 220 may include a light-passing port 221 configured for the emergent laser signals emitting from the corresponding laser transceiving module 100 and the reflected laser signals received by the corresponding laser transceiving module 100 to pass through. A specific shape of the light-passing port 221 at the bracket 220 may be determined according to the optical path, and the number thereof may be the same as the number of the laser transceiving modules 100. The light-passing port 221 may correspond to each laser transceiving module 100, respectively. The light-passing port 221 may function as a diaphragm. For example, the emergent laser signals emitting from the laser transceiving module 100 and the reflected laser signals received by the laser transceiving module 100 may pass through propagation paths formed by the light-passing port 221, but internal stray light outside the normal propagation path and background light entering from outside and other radar interference light (for example, external stray light) may be restricted. Propagation directions of the internal stray light and the external stray light often do not follow optical path directions of the normally-propagating emergent laser signals and reflected laser signals. In this arrangement, it may suppress the external background light, other radar interference light, and the internal stray light.

In addition, the emergent laser signals may be reflected by a target object 300 in a detection area and then return the reflected laser signals. Considering that the target object 300 usually produces diffuse reflection, an optical spot of the reflected laser signals may have a diameter larger than a diameter of the emergent laser signals. A central optical axis of the received laser signals may be aligned with the corresponding laser transceiving module 100. In addition, marginal laser may emit to an adjacent laser transceiving module 100, thereby causing crosstalk between channels of different laser transceiving modules 100. The light-passing port 221 may restrict the beam of the reflected laser signals emitting to the laser transceiving module 100, thereby suppressing crosstalk between the internal channels and improving the detection accuracy of the LiDAR 200.

In some embodiments, a mounting port 222 for mounting the galvanometer assembly 212 may also be formed at the bracket 220. It should be noted that a galvanometer bracket for mounting the galvanometer assembly 212 may be a mounting bracket different from the bracket 220. In one embodiment, the mounting port 222 for mounting the galvanometer assembly 212 may also be provided at the bracket 220, so that the galvanometer bracket for mounting the galvanometer assembly 212 may be integrated with a light-passing bracket through which light passes, reducing a part number, simplifying a structure, and reducing the difficulty and complexity of assembly.

According to the present disclosure, a light-absorbing layer (not shown in the figure) may be formed at a side of the bracket 220 facing the mirror lens assembly 211 and/or a side of the bracket 220 facing the laser transceiving module 100. As mentioned above, the bracket 220 may be opened and provided with the light-passing port 221. The light-passing port 221 may be configured to limit the stray light outside the optical paths of the emergent laser signals and the reflected laser signals, so that part of the light may emit to the bracket 220. The arrangement of the light-absorbing layer may reduce part of the light restricted by the bracket 220 to be reflected or scattered by the bracket 220 to emit to the laser transceiving module 100 to become new stray light, thereby reducing the stray light generated inside the LiDAR 200 and improving short-distance ranging capability.

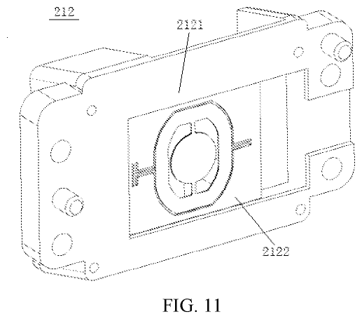

Further, as shown in FIG. 11, the galvanometer diaphragm (not shown in the figure) may be arranged at a front side of the working surface 2122 of the galvanometer assembly 212, and/or the light-absorbing layer (not shown in the figure) may be provided at a base on the working surface 2121 of the galvanometer assembly 212.

In some embodiments, the galvanometer assembly 212 may include a Micro-Electro-Mechanical System (MEMS) galvanometer. The MEMS galvanometer may include a mirror and a base. The mirror may be connected to the base via a connecting bridge. A working surface of the MEMS galvanometer may include the mirror part and the base. A surface of the material (may be silicon) of the base is relatively smooth and may cause reflecting or scattering. As mentioned above, the diameter of the optical spot of the reflected laser signals may be larger, and often larger than the area of the mirror. Therefore, part of marginal laser of the reflected laser signals may emit to the base. This part of the reflected laser signals may be reflected by the base and emit to the laser transceiving module 100 to become the internal stray light. Therefore, the galvanometer diaphragm with a certain aperture may be arranged in front of the MEMS galvanometer or the light-absorbing layer may be formed at the base. Therefore, the size and direction of the optical spot of the reflected laser signals emitting to the MEMS galvanometer may be determined while ensuring that the emergent laser signals and the reflected laser signals are not blocked. The stray light emitting to the MEMS galvanometer may be removed while considering the size of the optical spot of the reflected laser signals emitting to the MEMS, so that most of the reflected laser signals may fall on the mirror. In addition, the light-absorbing layer may be provided at the base. Even if part of the laser falls at the base, the light-absorbing layer may absorb this part of the laser, which may be not further reflected to become the stray light. In some embodiments, the light-absorbing layer may be one of a light-absorbing paper, a light-absorbing film, and an extinction dope.

According to the present disclosure, the light-absorbing layer (not shown in the figure) may be provided in a region of the inner side of the upper housing 201 under the window sheet 203. An area of the mirror of a mirror assembly 211 is limited, and the emergent laser signals and the reflected laser signals emitting to the mirror assembly 211 are unable to be completely received by the mirror assembly 211 (especially for the reflected laser signals with a larger diameter of the optical spot). Therefore, a rear of the mirror assembly 211 (for example, a region of the housing assembly under the window sheet 203) may need an extinction processing to prevent the emergent laser signals and the reflected laser signals that are not received by the mirror lens assembly 211 from being reflected by an inner wall of the upper housing 201 behind the mirror lens assembly 211 to form the stray light, thereby reducing the stray light generated inside the LiDAR 200. In some embodiments, the light-absorbing layer may include at least one of the light-absorbing paper, the light-absorbing film, and the extinction dope.

The laser transceiving module of the present disclosure may reduce the internal stray light, and the LiDAR may reduce the internal stray light, the external stray light, and crosstalk between the plurality of laser transceiving modules. A large random noise caused by the external stray light may be avoided. The noise of a point cloud may be significantly reduced. The ranging ability of the LiDAR may be improved. The detector may be avoided from being saturated in advance after the internal stray light is received by the receiving module. The reflected laser signals that rapidly return at a close distance cannot be responded. Leading interference may be formed to cause a short-distance blind region. The ranging ability and accuracy of the LiDAR may be improved. The crosstalk of optical path channels of the plurality of laser transceiving modules inside the LiDAR may be reduced. The accuracy of the LiDAR may be improved.

It should be noted that unless otherwise specified, the technical or scientific terms used in the present disclosure should have general meanings understood by the person skilled in the art to which the present disclosure belongs.

In the description of the present disclosure, it shall be understood that the terms such as “first” and “second” are merely intended for a purpose of description, and shall not be understood as an indication or implication of relative importance or implicit indication of a quantity of indicated technical features. In the description of the present disclosure, “a plurality of” means two or more, unless otherwise specifically defined.

Finally, it should be noted that the foregoing embodiments are intended for describing instead of limiting the technical solutions of the present disclosure. Although the present disclosure is described in detail with reference to the foregoing embodiments, the person skilled in the art should understand that modifications may be made to the technical solutions described in the foregoing embodiments or equivalent replacements may be made to some or all technical features thereof, without departing from the scope of the technical solutions. All these modifications or replacements shall fall within the scope of the claims and specification of the present disclosure. Particularly, the technical features mentioned in all embodiments may be combined in any manner, provided that no structural conflict occurs. The present disclosure is not limited to the specific embodiments disclosed in this specification but may include all technical solutions that fall within the scope of the claims.

What is claimed is:

1. A laser transceiving module, comprising:
a housing;
an emitting module configured to emit emergent laser signals;
a laser splitting module, the emergent laser signals emitting, through the laser splitting module, outwards and being reflected by a target object in a detection region to return reflected laser signals, the laser splitting module being configured to deflect the reflected laser signals; and
a receiving module configured to receive the deflected reflected laser signals,
wherein the emitting module, the laser splitting module, and the receiving module are fixed at the housing, and
wherein an extinction structure is arranged between the emitting module and the laser splitting module and is configured to prevent the emergent laser signals that are reflected by the laser splitting module from emitting to the receiving module.

2. The laser transceiving module according to claim 1,
wherein the extinction structure is arranged at the housing and comprises a first reflecting surface and a second reflecting surface that forms an angle with the first reflecting surface,
wherein one end of the first reflecting surface is close to the emitting module, and another end of the first reflecting surface is connected with the second reflecting surface, and
wherein one end of the second reflecting surface is connected with the first reflecting surface, and another end of the second reflecting surface is close to the laser splitting module.

3. The laser transceiving module according to claim 2, wherein each of the first reflecting surface and the second reflecting surface includes a plane, and the angle formed by the first reflecting surface and the second reflecting surface is an obtuse angle.

4. The laser transceiving module according to claim 2, wherein the second reflecting surface is approximately perpendicular to the laser splitting module.

5. The laser transceiving module according to claim 2, wherein a light-absorbing layer is formed on at least one of the first reflecting surface or the second reflecting surface.

6. The laser transceiving module according to claim 1,
wherein the emitting module comprises a laser device and a collimating module, the laser device is configured to generate the emergent laser signals, and the collimating module is configured to collimate the emergent laser signals, and
wherein the collimating module comprises a fast-axis collimating lens group and a slow-axis collimating lens group, a first emitting diaphragm is arranged at a front side of an emergent end of the collimating module, and a second emitting diaphragm is arranged between the fast-axis collimating lens group and the slow-axis collimating lens group.

7. The laser transceiving module according to claim 6, wherein the first emitting diaphragm includes a circular first light-passing hole.

8. The laser transceiving module according to claim 6, wherein the second emitting diaphragm comprises at least one second emitting sub-diaphragm, and each of the at least one second emitting sub-diaphragm comprises a plurality of light blocking blocks arranged up and down correspondingly.

9. The laser transceiving module according to claim 1,
wherein the receiving module comprises a focusing module and a detector, the focusing module is configured to converge the reflected laser signals, and the detector is configured to receive the converged reflected laser signals, and
wherein the focusing module comprises a receiving converging lens group and a receiving correcting lens group, a first receiving diaphragm is arranged between the receiving converging lens group and the receiving correcting lens group, and a second receiving diaphragm is arranged at a front side of an emergent end of the focusing module.

10. The laser transceiving module according to claim 9, wherein the first receiving diaphragm is movable and adjustable along axial and radial directions of an optical axis of the receiving module.

11. The laser transceiving module according to claim 10, wherein a detachable adjusting base is provided at the first receiving diaphragm, the first receiving diaphragm is moved and adjusted by clamping the adjusting base, and after the first receiving diaphragm is adjusted and fixed, the adjusting base is removed.

12. The laser transceiving module according to claim 9, wherein the first receiving diaphragm includes a circular second light-passing hole, and the second receiving diaphragm includes a third light-passing hole.

13. A LiDAR, comprising at least one laser transceiving module, wherein the at least one laser transceiving module comprises:
a housing;
an emitting module configured to emit emergent laser signals;
a laser splitting module, the emergent laser signals emitting, through the laser splitting module, outwards and being reflected by a target object in a detection region to return reflected laser signals, the laser splitting module being configured to deflect the reflected laser signals; and
a receiving module configured to receive the deflected reflected laser signals,
wherein the emitting module, the laser splitting module, and the receiving module are fixed at the housing, and
wherein an extinction structure is arranged between the emitting module and the laser splitting module and is configured to prevent the emergent laser signals that are reflected by the laser splitting module from emitting to the receiving module.

14. The LiDAR according to claim 13, further comprising:
a galvanometer assembly configured to receive the emergent laser signals emitting from the laser transceiving module, emit the emergent laser signals outwards to scan, and receive the reflected laser signals returned coaxially and emit the reflected laser signals to the laser transceiving module; and
a housing assembly comprising a base and an upper housing, wherein a window sheet is formed on a side wall of the upper housing, the galvanometer assembly and the at least one laser transceiving module are arranged in the housing assembly, the emergent laser signals emit outwards through the window sheet, and the reflected laser signals emit, through the window sheet, to the housing assembly.

15. The LiDAR according to claim 14, wherein the window sheet is arranged obliquely.

16. The LiDAR according to claim 14, further comprising a mirror lens assembly, wherein the mirror lens assembly comprises mirror lenses, a number of the mirror lenses corresponds to a number of the at least one laser transceiving module, the emergent laser signals emitting from each of the at least one laser transceiving module are reflected by a corresponding mirror lens and emit to the galvanometer assembly, and the reflected laser signals received by the mirror lens assembly emit to the mirror lens, and emit to the corresponding laser transceiving module after being reflected by the mirror lens.

17. The LiDAR according to claim 16, further comprising:
a bracket between the laser transceiving module and the mirror lens assembly; and
a light-passing port formed at the bracket, the emergent laser signals that emit from the corresponding laser transceiving module passing through the light-passing port, and the reflected laser signals being received, through the light-passing port, by the corresponding laser transceiving module.

18. The LiDAR according to claim 17, wherein a light-absorbing layer is formed on at least one of a side of the bracket facing the mirror lens assembly or a side of the bracket facing the laser transceiving module.

19. The LiDAR according to claim 14, wherein at least one of the following applies:
one galvanometer diaphragm is arranged at a front side of a working surface of the galvanometer assembly, or
a light-absorbing layer is provided at a base on the working surface of the galvanometer assembly.

20. The LiDAR according to claim 14, wherein a light-absorbing layer is provided at an inner surface of the upper housing below the window sheet.
